(19) United States
(12) Patent Application Publication
(10) Pub. No.: US 2010/0217728 A1
(43) Pub. Date: Aug. 26, 2010

(54) Multiproduct Advertising Development and Exposure

(76) Inventor: Lance Fein, Davie, FL (US)

Correspondence Address: Lance Fein, 4650 SW 61st Ave, Davie, FL, 33314, US

(21) Appl. No.: 12/380,204

(22) Filed: Feb. 26, 2009

(51) Int. Cl. G06Q 90/00

(52) U.S. Cl. 705/500

(57) ABSTRACT

Innoventions Inc. a corporation in the state of Florida has developed a new method of multimedia advertising and marketing to mass markets. In today's economic climate, businesses need to find a model that increases their exposure to consumers without a respective cost increase. This is a unique method of multiproduct advertising development and exposure. The concept is designed to decrease the high cost of advertising to corporations or sellers without decreasing the effectiveness of the advertisement.

### BACKGROUND OF INVENTION

Currently, the industry standard of advertising and marketing is:

Companies or parties vie for advertising exposure.

This exposure may be printed, video, multi media, or audio.

The space or opportunity for capturing the exposure is limited and the cost of the exposure is directly related to the size of the market the advertisement reaches or is exposed to. For example, Super Bowl commercial time is significantly more expensive then the same time slot on any other day.

### BRIEF SUMMARY OF INVENTION

The Invention applies to the method of doing business for individuals, firms, and businesses in the advertising and marketing industries. Unlike current advertising and marketing campaigns (which are cost prohibitive and limited in the availability of quality exposures) MADE uniquely shares the cost of advertising and marketing between one or more parties and allows companies to share the advertising and marketing opportunities.
Our method proposes allowing multiple products to share a single advertisement thereby allowing the companies involved to split the cost of advertising.

### DETAILED DESCRIPTION OF THE INVENTION

MADE is designed to simultaneously share companies cost of advertising and marketing while increasing the quality and quantity of advertising available to them and their respective exposure. This is accomplished by creating advertisements that promote more than one product within a single advertising medium (Magazine, newspaper, radio, television, internet etc.)

The premise behind MADE allows companies to share the cost of advertising, not only for high profile spots, but all spots.

The back cover of a magazine is an exclusive and expensive advertisement. Furthermore, these covers are sold well in advance. Using MADE, companies products could be advertised simultaneously thereby sharing the cost of the product, increasing overall exposure, and creating stronger associations.

Example: If BMW is advertising a car on the back cover of a magazine, they could partner will Michelin Tires. The driver could be wearing a Movado watch, Ray-Ban Sunglasses, or a Polo shirt. Taking the advertisement further, the driver or passenger could be pictured having a picnic with the car behind them. On the picnic blanket could be a bottle of Dewars Scotch. Or the driver could be getting out of his car and removing Calloway Golf Clubs from the trunk.

All of these name brands could share in the cost of advertising - from the production of the advertisement to the final product.

Example 2: A television commercial could combine multiple products in a similar way. Heinz ketchup uses the premise their Ketchup is so rich and thick, you have to wait and wait and wait for it to pour out the bottle.

Snickers candy bar uses the premise that if you are not going anywhere for awhile and are hungry, you can conveniently eat a Snickers bar and satisfy your hunger.

A TV commercial could show a person opening the Heinz ketchup bottle, turning it over, and then waiting for the ketchup to come out. And then while waiting, they would open up a snickers bar, while the voice over said “not going anywhere for awhile”, which is Snickers slogan.

These two examples clearly demonstrate uses of MADE advertising. In the first example, the following companies could share the cost of the advertisement:

BMW, Movado, Ray-Ban, Polo, Dewars, and Michelin

Furthermore, the companies could choose to advertise together not just for exposure but to promote cross branding. In this particular example, if you drive a BMW you should be wearing a Movado, wearing Ray-Bans and drinking Dewars.

This method of advertising is completely new and unique because it allows the advertising and promotion of multiple products within a single advertisement.

Multiple products have been advertised together before, but under an entirely different premise. There are several types of advertisements featuring multiple brand names which already occur and have become commonplace. These advertisements would therefore be grandfathered in and would not infringe upon this utility patent. These advertisements include:
I. Store Promotions/Sales
   A grocery store advertising sales on multiple items, milk, eggs, fruit, paper towels JC Penney advertising a Labor Day sale with multiple brand name items Exempt because there is a single vendor selling multiple items and the advertisement is promoting the “STORE” or the “SALE” not the products.
II. Product promotions
   A single product advertising which also lists/promotes one or more stores which carry/sell the product.
   Extra Strength Tylenol can be purchased at Walgreens, CVX, Wal-Mart, Etc. Exempt because there is only one product or brand name being advertised (Tylenol). Even though CVX, Walgreens, and Wal-Mart have generic brands, their products are not being advertised, only their function as a vendor.
III. Public Events (Sporting Events, Concerts, Promotional Events, Charity Events)
   Sponsors who advertise at these events or during the simultaneous broadcast of the event either through screen boarders, logos, or product placement are exempt.
IV. Products/Brands that already advertise together or are currently viewed as being intertwined or dependent upon one another.
   Example: Dell computers and Intel Processors have already established a relationship that is commonly known. Similarly any products that have been advertised together (to the point they have become commonly known together) are exempt from infringement.
V. Products that are bundled together.
   Example: Apple's Iphone and ATT service network
VI. Products which require another specific product in order to work
   Example: Video Games. When video games are advertised they are usually advertised with the game consoles that play them. (Xbox, Playstation, Wii, etc.)

### Effectiveness

With the increasing cost of mass media advertising, and corporations paying millions of dollars for 30-second prime time advertising spots, MADE is an idea whose itme has come. By providing multiple product placement and exposure within a single advertisement, regardless of medium the following golas are achieved:
1. Reduction of cost on development
2. Reduction of cost of production—Advertising agencies no longer need to develop or produce two or more separate commercials.
3. More exposure at a lowered cost—the opportunity for smaller companies to compete for advertising exposure that would not have previously been possible.
4. Lower end user cost to consumers as the cost of advertising has decreased.

I. MADE is a new way for products to be advertised allowing for two or more products or brand names to be advertised simultaneously within the same advertisement.

II. MADE allows for the sharing of the cost of the advertisement (production, design, set, staff, print, broadcast etc.) to be shared by two or more companies thereby providing both new and additional opportunities for companies to secure advertising medium space in a market that is in high demand and limited supply.

III. MADE allows for companies to develop cross branding with one another thereby creating greater exposure.
